(19) United States
(12) Patent Application Publication
(10) Pub. No.: US 2016/0378238 A1
(43) Pub. Date: Dec. 29, 2016

(54) CONTEXT AWARE SECURE TOUCH IMPLEMENTATION OF INTEGRATED TOUCH

(71) Applicant: Intel Corporation, Santa Clara, CA (US)

(72) Inventors: Wah Yiu Kwong, Beaverton, OR (US); Hong W. Wong, Portland, OR (US); Zhiming J. Zhuang, Sammamish, WA (US)

(73) Assignee: Intel Corporation, Santa Clara, CA (US)

(21) Appl. No.: 14/752,732

(22) Filed: Jun. 26, 2015

(51) Int. Cl. G06F 3/041; G09G 5/00

(52) U.S. Cl. CPC G06F 3/0416; G06F 3/0412; G09G 5/003; G09G 2370/16; G09G 2354/00

(57) ABSTRACT

Methods and apparatus relating to context aware secure touch implementation of integrated touch are described. In an embodiment, a touch sensitive display device is configured into one or more touch active regions and one or more touch inactive regions. The one or more of the touch inactive regions are capable to communicate wireless signals. Other embodiments are also disclosed and claimed.

### FIELD

The present disclosure generally relates to the field of electronics. More particularly, an embodiment relates to context aware secure touch implementation of integrated touch.

### BACKGROUND

Portable computing devices generally rely on a touch interface for at least a portion of data input and interaction with applications. As such, the implementation of the touch interface has become an integral part of how successful portable computing devices can become in the market.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-2 illustrate various regions of a display device, according to some embodiments.

FIG. 3 illustrates a flow diagram of a method to provide multi-factor authentication using a switchable integrated touch enabled device, in accordance with an embodiment.

FIGS. 4-7 illustrate block diagrams of embodiments of computing systems, which may be utilized to implement various embodiments discussed herein.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

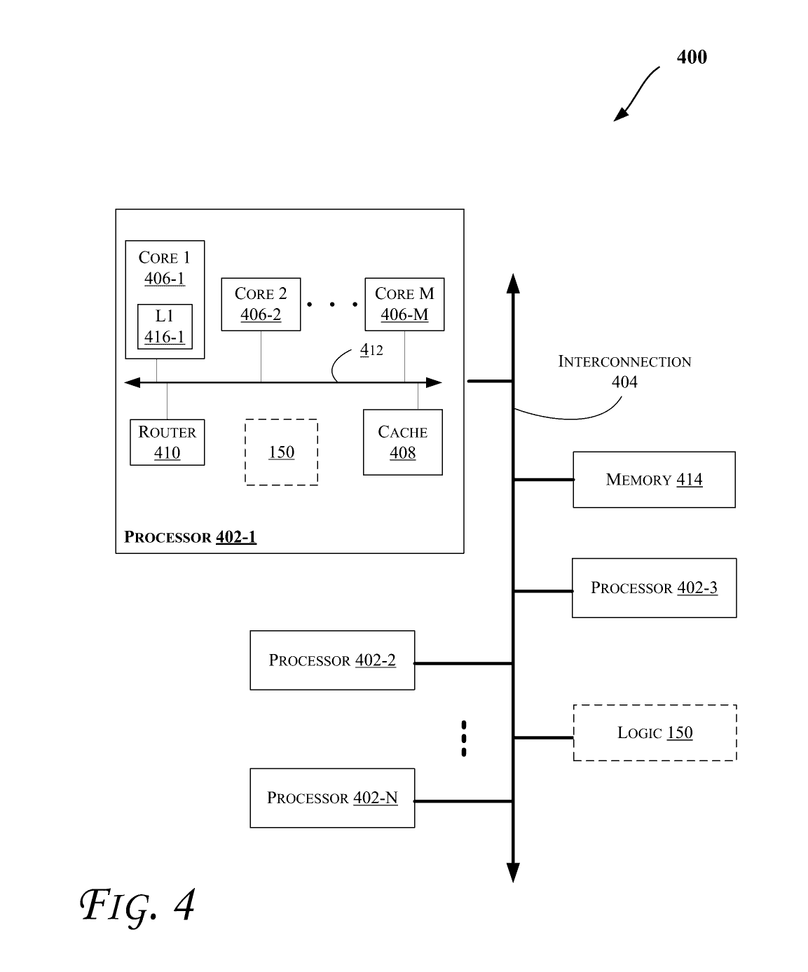

As discussed herein, an integrated touch enabled device allows the graphics subsystem (e.g., Graphics Processing Unit (GPU) or other graphics logic) or another general-purpose processing unit (such as the processor(s) or processor cores discussed with reference to FIGS. 4-7) to process information associated with provision of a touch interface. When compared to more traditional touch interfaces that rely on a touch controller, integrated touch enabled devices can have access to much larger resources on a host device, e.g., supporting a higher frame rate, reduced latency, reduced implementation cost (e.g., by eliminating dedicated controller logic or microprocessor), reduced power consumption, easier support for different types of sensor designs, easier access for changing code (e.g., driver, firmware, etc.), etc. Further, NFC (Near Field Communication) is generally supported in most portable computing devices. However, due to potential conflict or interference issues between NFC and current touch display sensor implementations, these features may not readily co-exist without added cost and/or complexity.

To this end, some embodiments provide techniques for context aware secure touch implementation of integrated touch, e.g., allowing for co-existence of both NFC and integrated touch enabled device features on the same computing device. Alternatively, other types of wireless communication may be used such as Bluetooth® communication, Radio Frequency Identification (RFID), or other types of wireless communication such as those discussed with reference to FIGS. 4-7. As discussed herein, co-existence generally refers to provision of a scheme for an end user or application to use both features (e.g., simultaneously) without much limitation, added cost, or complexity.

For example, one embodiment allows a user (or software application) to request a portion of a touch screen (e.g., employing an integrated touch enabled device design) to operate as an NFC (and/or another wireless) receiver (e.g., utilizing a transparent antenna). As discussed herein, a transparent antenna generally refers to an antenna that has been provided over or under a glass cover (or glass or transparent) portion of a display device, such as by etching, printing (e.g., inkjet printing), etc. Various technologies may be used to provide a transparent antenna, including, for example, a metal mesh, ITO (Indium Tin Oxide), FTO (Fluorine-Doped Tin Oxide), etc. Such embodiments allow for a portable computing device to be operated in a user-friendly, low cost, and/or secure way, e.g., to make online payments, securely access data online, etc. Hence, some embodiments allow for a multi-factor authentication including an NFC (and/or other wirelessly transmitted) token and/or secure signature capture, e.g., by utilizing a combination of transparent antenna, NFC (and/or other wireless technologies), and/or integrated touch enabled device.

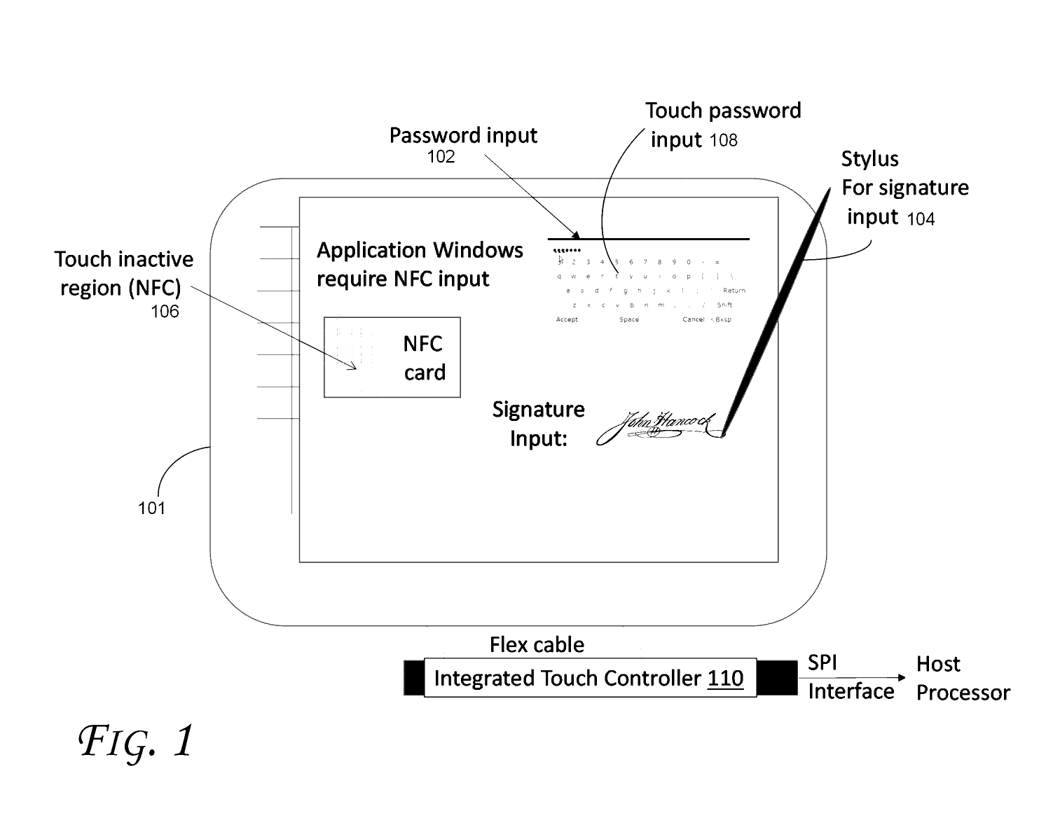

FIG. 1 illustrates various regions of a display device 101, according to an embodiment. Various types of display devices with integrated touch display technology may be used for display device 101, such as in-cell or on-cell integrated touch display devices. As discussed herein, integrated touch display devices may sometimes provide a more efficient solution as a touch sensitive display device that weighs significantly less when compared to more traditional touch sensitive display devices with a separate overlaid touch sensitive sensor layer. As shown in FIG. 1, multi-factor authentication is provided through a partial switchable integrated touch display 101.

For example, password input area 102 (e.g., in the form of touch input by row and column) is provided in one portion of the display, while signature input 104 (e.g., using a stylus or user finger) is provided in another portion of the display. The display may also include another portion 106 to provide NFC information (e.g., via an NFC card or adapter) for applications that require NFC input. In an embodiment, the NFC transmit/receive antenna operates using radio frequency signals in the 13 MHz frequency range (for example, at 13.56 MHz, or more generally 13.x MHz, where “x” denotes a numerical value) frequency range.

Moreover, region 106 may be provided in a region of the display that is inactive for touch input, while signature input 104 and/or touch password input regions are provided in an active region for touch. In an embodiment, areas 104 and/or 108 may be touch active regions and, for example, include sense lines to detect touch, gesture(s), or pen/stylus input (and/or implemented with a transparent antenna as further discussed herein).

As shown in FIG. 1, display device 101 is coupled to a host processor (such as the processors discussed with reference to FIGS. 4-7) via an integrated touch controller logic 110 (through flexible cabling and an interface/interconnect (e.g., SPI (Serial Protocol Interface), etc.). Logic 110 may be provided on a controller board in an embodiment.

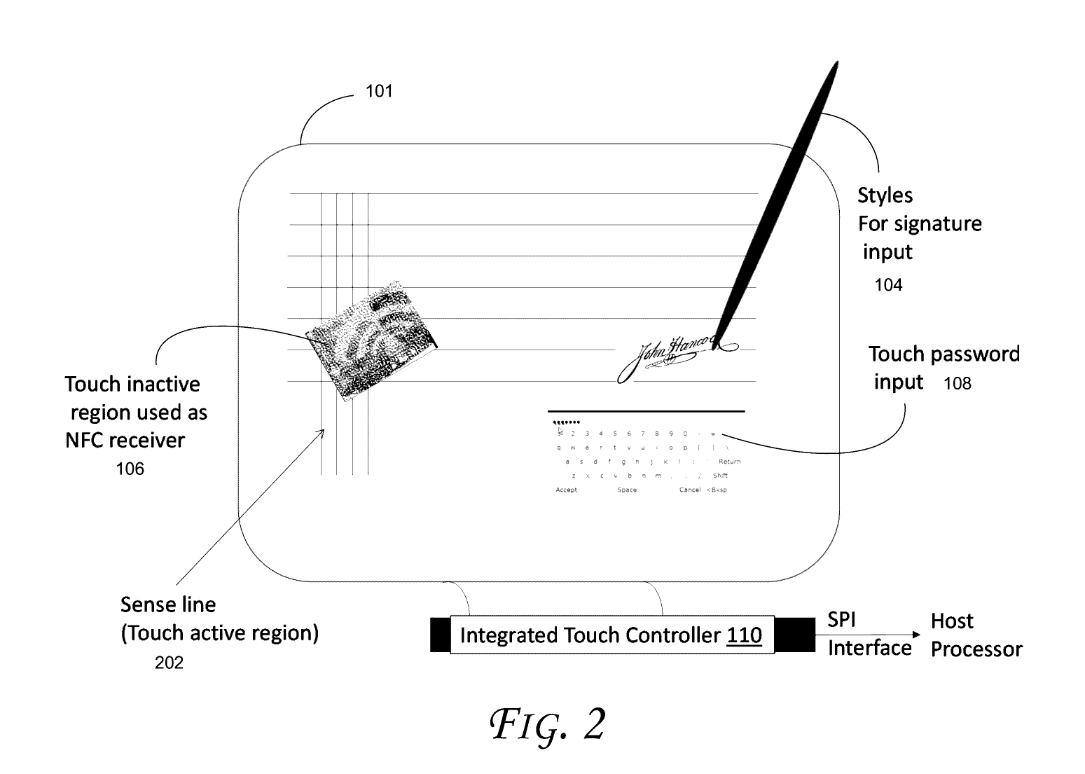

FIG. 2 illustrates various regions of the display device 101, according to an embodiment. FIG. 2 shows similar regions as FIG. 1, including items 104, 106, 108, and 110. As shown in FIG. 2, touch inactive region 106 includes a transparent antenna to allow the region to act as an NFC receiver. Also, region 108 has been moved from the top portion of the display device 101 of FIG. 1 to the bottom portion of the display device 101 of FIG. 2. FIG. 2 also illustrates sense lines 202 to sense/detect touch input in the active regions of the display device 101. As shown, sense lines 202 may be arranged in a rows and columns.

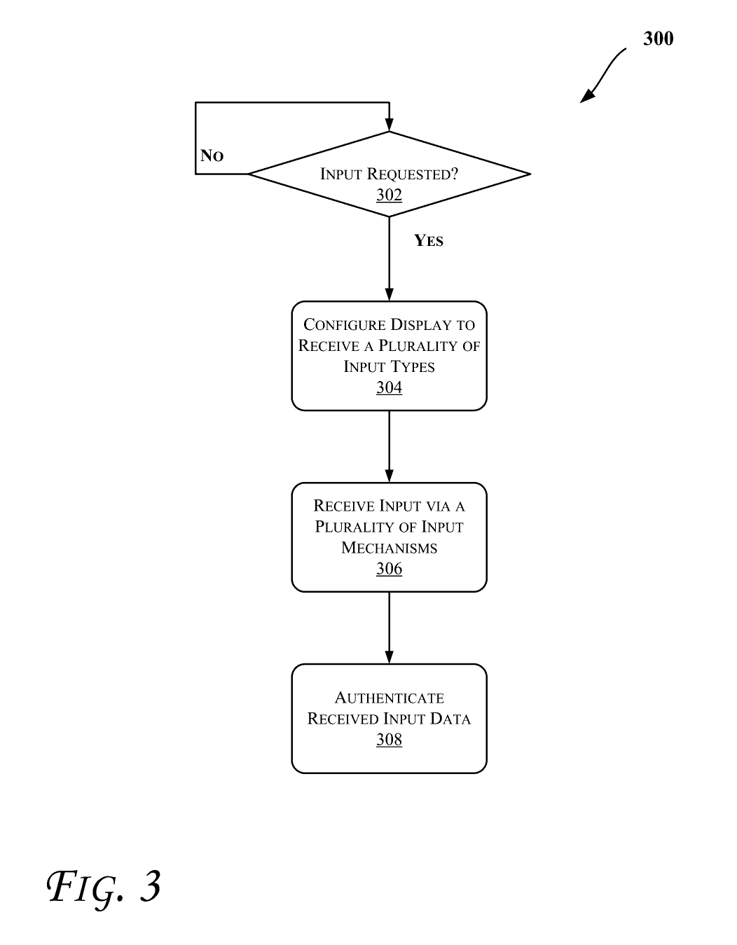

FIG. 3 illustrates a flow diagram of a method 300 to provide multi-factor authentication using a switchable integrated touch enabled device, in accordance with an embodiment. In an embodiment, various components discussed with reference to FIGS. 1-2 and 4-7 may be utilized to perform one or more of the operations discussed with reference to FIG. 3. In an embodiment, method 300 is implemented in logic such as logic 150 of FIGS. 4-7. While various locations for logic 150 has been shown in FIGS. 4-7, embodiments are not limited to those and logic 150 may be provided in any location with access to the integrated touch controller logic 110, including for example, within logic 110, coupled to logic 110, inside display device 101, etc.

Referring to FIGS. 1-3, at operation 302, it is determined whether input data is requested. For example, a software application, an operating system, a web site, etc. may request data (e.g., authentication data, password, payment information, etc.) from a user, e.g., by display a message on a display device (e.g., device 101 of FIGS. 1-2). Moreover, the requesting agent of operation 302 may allow for left-handed or right-handed user configuration when signature input is needed. The partial active pen/stylus input area may be user/application configurable as well.

At an operation 304, the display device (e.g., device 101) is configured (e.g., by logic 150 instructing controller logic 110 to do so, for example, at the direction or per the request of the requesting agent of operation 302) to receive the requested data of operation 302, e.g., with a plurality of input regions/types such as discussed with reference to FIGS. 1-2. Hence, one or more areas/regions of the display may be configured to receive touch input (also referred to as touch active areas/regions) and one or more other areas/regions of the display may be configured to not receive touch input (also referred to as touch inactive areas/regions). The inactive regions/areas may be configured (e.g., using a transparent antenna) to communicate/drive NFC RF (Radio Frequency) or other types of wireless signals (including those discussed herein with reference). In an embodiment, the entire (or a significant portion) of the display device 101 may be configurable to receive touch input (e.g., via sense lines discussed with reference to FIGS. 1-2) and/or wireless signals. Hence, a (e.g., switchable) transparent antenna and/or (e.g., switchable) touch sense lines or cells may be provided over the entire (or a significant portion) of the display device 101 to facilitate the configuration of operation 304.

At an operation 306, the requested data is received via the plurality of input mechanisms (and passed to the requesting agent of operation 302). Operation 308 authenticates the received data of operation 308. For example, an application may request user authentication and secure payment information at operation 302. The display may be configured (e.g., by logic 150) to receive user authentication information (e.g., signature, password, finger print, etc.) as well as secure payment information (e.g., credit card, bank account number, debit card, electronic payment information (such as Bitcoin™ or PayPal™ account information), etc.) via NFC at operation 306.

Some embodiments may utilize one or more components of computing systems that include one or more processors (e.g., with one or more processor cores), such as those discussed with reference to FIGS. 4-7, including for example mobile computing devices such as a smartphone, tablet, UMPC (Ultra-Mobile Personal Computer), laptop computer, Ultrabook™ computing device, wearable devices (such as smart watch, smart glasses, smart bracelets, and the like), etc. More particularly, FIG. 4 illustrates a block diagram of a computing system 400, according to an embodiment. The system 400 may include one or more processors 402-1 through 402-N (generally referred to herein as “processors 402” or “processor 402”).

The processors 402 may be general-purpose CPUs (Central Processing Units) and/or GPUs (Graphics Processing Units) in various embodiments. The processors 402 may communicate via an interconnection or bus 404. Each processor may include various components some of which are only discussed with reference to processor 402-1 for clarity. Accordingly, each of the remaining processors 402-2 through 402-N may include the same or similar components discussed with reference to the processor 402-1.

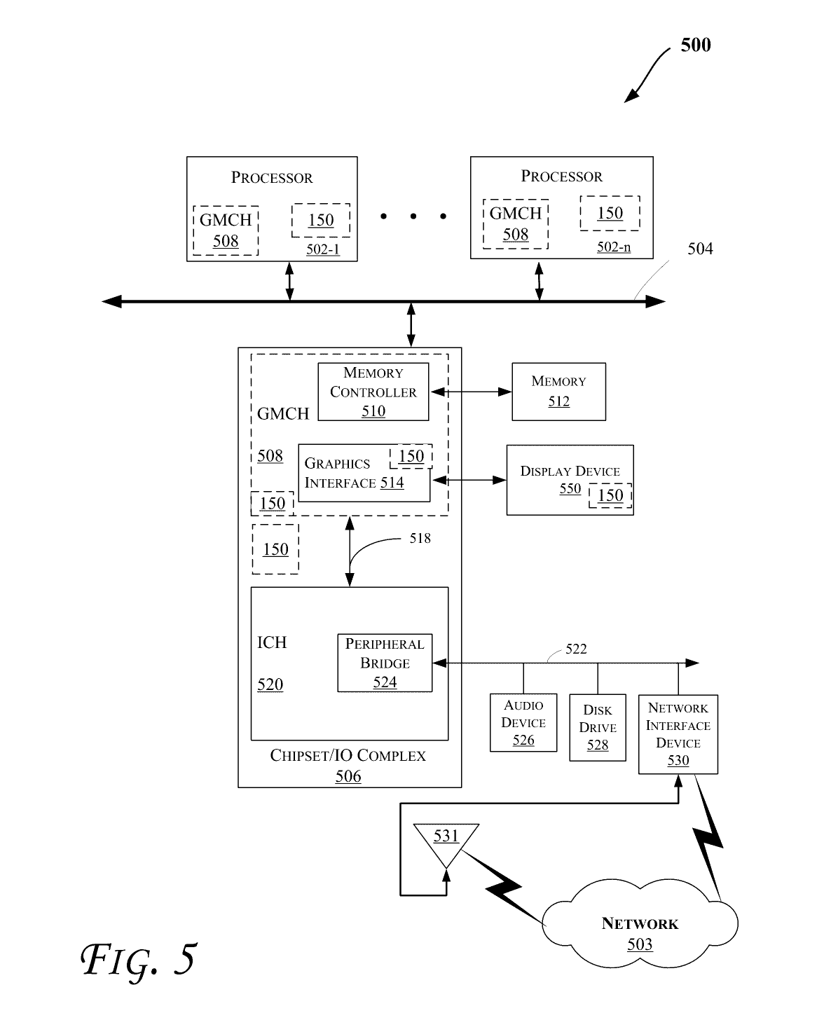

In an embodiment, the processor 402-1 may include one or more processor cores 406-1 through 406-M (referred to herein as “cores 406,” or “core 406”), a cache 408, and/or a router 410. The processor cores 406 may be implemented on a single integrated circuit (IC) chip. Moreover, the chip may include one or more shared and/or private caches (such as cache 408), buses or interconnections (such as a bus or interconnection 412), graphics and/or memory controllers (such as those discussed with reference to FIGS. 5-7), or other components.

In one embodiment, the router 410 may be used to communicate between various components of the processor 402-1 and/or system 400. Moreover, the processor 402-1 may include more than one router 410. Furthermore, the multitude of routers 410 may be in communication to enable data routing between various components inside or outside of the processor 402-1.

The cache 408 may store data (e.g., including instructions) that are utilized by one or more components of the processor 402-1, such as the cores 406. For example, the cache 408 may locally cache data stored in a memory 414 for faster access by the components of the processor 402 (e.g., faster access by cores 406). As shown in FIG. 4, the memory 414 may communicate with the processors 402 via the interconnection 404. In an embodiment, the cache 408 (that may be shared) may be a mid-level cache (MLC), a last level cache (LLC), etc. Also, each of the cores 406 may include a Level 1 (L1) cache (516-1) (generally referred to herein as “L1 cache 416”) or other levels of cache such as a Level 2 (L2) cache. Moreover, various components of the processor 402-1 may communicate with the cache 408 directly, through a bus (e.g., the bus 412), and/or a memory controller or hub.

As shown, system 400 may also include logic 150 and/or 110 to control configuration of a display device such as device 101. Also, while some optional locations of logic 150 are shown in FIGS. 4-7, these locations are for illustrative purposes only and item 150 may be located elsewhere in these computing systems and embodiments are not limited to the locations shown in these figures.

FIG. 5 illustrates a block diagram of a computing system 500 in accordance with an embodiment. The computing system 500 may include one or more Central Processing Units (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)).

Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. In an embodiment, one or more of the processors 502 may be the same or similar to the processors 402 of FIG. 4. Further, one or more components of system 500 may include logic 150 and/or 110, discussed with reference to FIGS. 1-4 (including but not limited to those locations illustrated in FIG. 5). Also, the operations discussed with reference to FIGS. 1-4 may be performed by one or more components of the system 500.

A chipset 506 may also communicate with the interconnection network 504. The chipset 506 may include a graphics memory control hub (GMCH) 508, which may be located in various components of system 500 (such as those shown in FIG. 5). The GMCH 508 may include a memory controller 510 that communicates with a memory 512 (which may be the same or similar to the memory 414 of FIG. 4). The memory 512 may store data, including sequences of instructions, that may be executed by the CPU 502, or any other device included in the computing system 500. In one embodiment, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The GMCH 508 may also include a graphics interface 514 that communicates with the display device 550. In one embodiment, the graphics interface 514 may communicate with the display device via an accelerated graphics port (AGP) or Peripheral Component Interconnect (PCI) (or PCI express (PCIe) interface). In an embodiment, the display (such as a flat panel display) may communicate with the graphics interface 514 through, for example, a signal converter that translates a digital representation of an image stored in a storage device such as video memory or system memory into display signals that are interpreted and displayed by the display device. The display signals produced by the display device may pass through various control devices before being interpreted by and subsequently displayed on the display device 550. Also, display device 550 may be the same as or similar to the display device 101 discussed with reference to FIGS. 1-3.

A hub interface 518 may allow the GMCH 508 and an input/output control hub (ICH) 520 to communicate. The ICH 520 may provide an interface to I/O device(s) that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530 (which is in communication with the computer network 503). Other devices may communicate via the bus 522. As shown, the network interface device 530 may be coupled to an antenna 531 (such as a transparent antenna) to wirelessly (e.g., via a Bluetooth® interface, an Institute of Electrical and Electronics Engineers (IEEE) 802.11 interface (including IEEE 802.11a/b/g/n/ac, an NFC (Near Field Communication) interface, etc.), cellular interface, including 3G (third generation), 4G (fourth generation), LPE (Low Power Embedded) interfaces, etc.) communicate with the network 503. Other devices may communicate via the bus 522. Also, various components (such as the network interface device 530) may communicate with the GMCH 508. In addition, the processor 502 and the GMCH 508 may be combined to form a single chip. Furthermore, a graphics accelerator may be included within the GMCH 508 in other embodiments.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

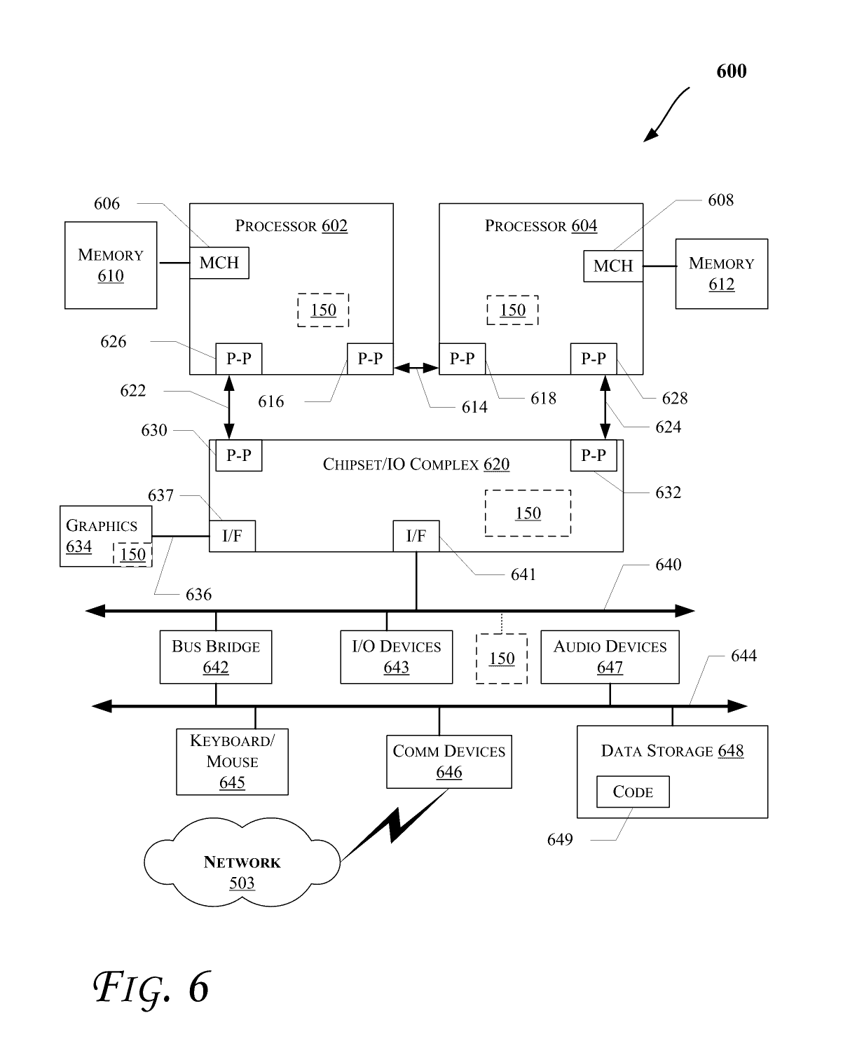

FIG. 6 illustrates a computing system 600 that is arranged in a point-to-point (PtP) configuration, according to an embodiment. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (MCH) 606 and 608 to enable communication with memories 610 and 612. The memories 610 and/or 612 may store various data such as those discussed with reference to the memory 512 of FIG. 5.

In an embodiment, the processors 602 and 604 may be one of the processors 502 discussed with reference to FIG. 5. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a graphics circuit 634 via a graphics interface 636, e.g., using a PtP interface circuit 637. Graphics circuit 634 may in turn drive various images for display on a display device (such as display device 101 of FIGS. 1-3).

At least one embodiment may be provided within the processors 602 and 604. Further, one or more components of system 600 may include logic 150 and/or 110, discussed with reference to FIGS. 1-5 (including but not limited to those locations illustrated in FIG. 6). Other embodiments, however, may exist in other circuits, logic units, or devices within the system 600 of FIG. 6. Furthermore, other embodiments may be distributed throughout several circuits, logic units, or devices illustrated in FIG. 6.

The chipset 620 may communicate with a bus 640 using a PtP interface circuit 641. The bus 640 may communicate with one or more devices, such as a bus bridge 642 and I/O devices 643. Via a bus 644, the bus bridge 642 may communicate with other devices such as a keyboard/mouse 645, communication devices 646 (such as modems, network interface devices, or other communication devices that may communicate with the computer network 503), audio I/O device 647, and/or a data storage device 648. The data storage device 648 may store code 649 that may be executed by the processors 602 and/or 604.

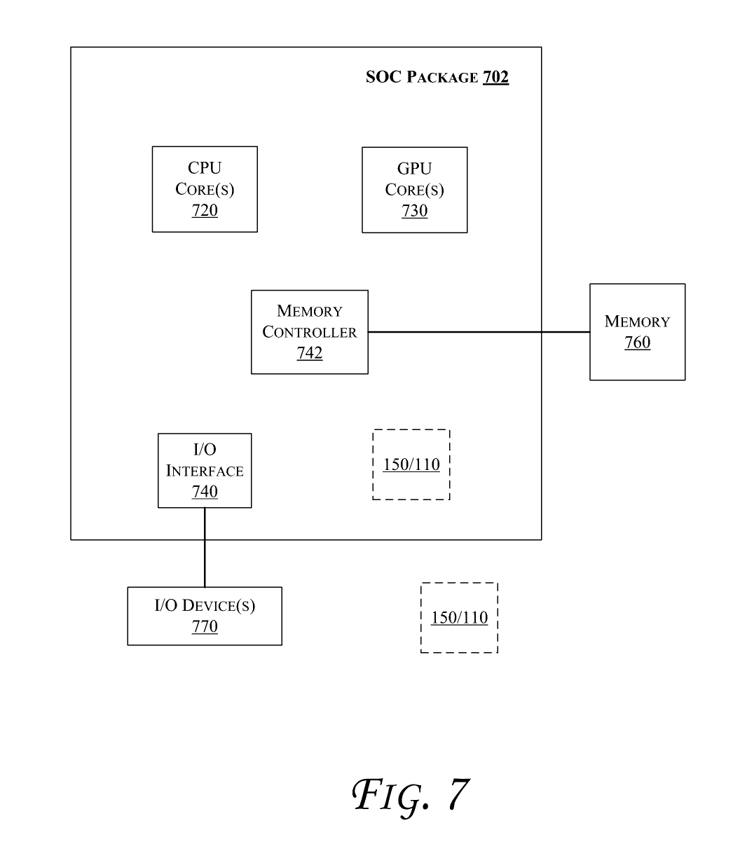

In some embodiments, one or more of the components discussed herein can be embodied as a System On Chip (SOC) device. FIG. 7 illustrates a block diagram of an SOC package in accordance with an embodiment. As illustrated in FIG. 7, SOC 702 includes one or more Central Processing Unit (CPU) cores 720, one or more Graphics Processing Unit (GPU) cores 730, an Input/Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 720 may include one or more other components, e.g., as discussed with reference to the other figures herein. In one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 (which may be similar to or the same as memory discussed herein with reference to the other figures) via the memory controller 742. In an embodiment, the memory 760 (or a portion of it) can be integrated on the SOC package 702.

The I/O interface 740 may be coupled to one or more I/O devices 770, e.g., via an interconnect and/or bus such as discussed herein with reference to other figures. I/O device(s) 770 may include one or more of a keyboard, a mouse, a touchpad, a display device, an image/video capture device (such as a camera or camcorder/video recorder), a touch screen, a speaker, or the like. Furthermore, SOC package 702 may include/integrate logic 150 and/or 110 in some embodiments. Alternatively, logic 150 and/or 110 may be provided outside of the SOC package 702 (i.e., logic 110 and/or 150 is provided as a discrete logic).

Moreover, the scenes, images, or frames discussed herein (e.g., which may be processed by the graphics logic in various embodiments) may be captured by an image capture device (such as a digital camera (that may be embedded in another device such as a smart phone, a tablet, a laptop, a stand-alone camera, etc.) or an analog device whose captured images are subsequently converted to digital form). Moreover, the image capture device may be capable of capturing multiple frames in an embodiment. Further, one or more of the frames in the scene are designed/generated on a computer in some embodiments. Also, one or more of the frames of the scene may be presented via a display (such as the display discussed with reference to FIGS. 5 and/or 6, including for example a flat panel display device, etc.).

The following examples pertain to further embodiments. Example 1 includes an apparatus comprising: logic, the logic at least partially comprising hardware logic, to cause configuration of a touch sensitive display device into one or more touch active regions and one or more touch inactive regions, wherein the one or more of the touch inactive regions are capable to communicate wireless signals. Example 2 includes the apparatus of example 1, wherein the one or more of the touch inactive regions are capable to communicate the wireless signals in accordance with one or more of: Near Field Communication (NFC) interface, Bluetooth interface, an RFID (Radio Frequency Identification) interface, a cellular interface, or an Institute of Electrical and Electronics Engineers (IEEE) 802.11 interface. Example 3 includes the apparatus of example 1, wherein the touch sensitive display device is to comprise a transparent antenna to communicate the wireless signals. Example 4 includes the apparatus of example 3, wherein the transparent antenna is to be provided by one or more technologies selected from a group comprising: metal mesh, ITO (Indium Tin Oxide), FTO (Fluorine-Doped Tin Oxide), or inkjet printing. Example 5 includes the apparatus of example 1, wherein the touch active regions are capable to receive touch or stylus input. Example 6 includes the apparatus of example 1, wherein the display device is to comprise an integrated touch display device. Example 7 includes the apparatus of example 6, wherein the integrated touch display device is one of an in-cell or an on-cell integrated touch display device. Example 8 includes the apparatus of example 1, further comprising integrated touch controller board to configure the touch sensitive display device into the one or more touch active regions and one or more touch inactive regions in response to a request by the logic. Example 9 includes the apparatus of example 1, wherein a portable computing device is to comprise the logic. Example 10 includes the apparatus of example 9, wherein the portable computing device is to comprise one or more of: a System On Chip (SOC) device; a processor, having one or more processor cores; a flat panel display device, and memory. Example 11 includes the apparatus of example 9, wherein the portable computing device is to comprise one of: a smartphone, a tablet, a phablet, a UMPC (Ultra-Mobile Personal Computer), a laptop computer, an Ultrabook™ computing device, and a wearable device. Example 12 includes the apparatus of example 1, wherein one or more of the logic, a processor having one or more processor cores, one or more sensors, and memory are on a single integrated circuit die.

Example 13 includes a method comprising: configuring a touch sensitive display device into one or more touch active regions and one or more touch inactive regions, wherein the one or more of the touch inactive regions are capable to communicate wireless signals. Example 14 includes the method of example 13, further comprising the one or more of the touch inactive regions being capable to communicate the wireless signals in accordance with one or more of: Near Field Communication (NFC) interface, Bluetooth interface, an RFID interface, a cellular interface, or an Institute of Electrical and Electronics Engineers (IEEE) 802.11 interface. Example 15 includes the method of example 13, further comprising the touch sensitive display device communicating the wireless signals via a transparent antenna. Example 16 includes the method of example 13, further comprising the touch active regions receiving touch or stylus input. Example 17 includes the method of example 13, further comprising an integrated touch controller board configuring the touch sensitive display device into the one or more touch active regions and one or more touch inactive regions.

Example 18 includes a computer-readable medium comprising one or more instructions that when executed on at least one processor configure the at least one processor to perform one or more operations to: configure a touch sensitive display device into one or more touch active regions and one or more touch inactive regions, wherein the one or more of the touch inactive regions are capable to communicate wireless signals. Example 19 includes the computer-readable medium of example 18, further comprising one or more instructions that when executed on the at least one processor configure the at least one processor to perform one or more operations to cause the one or more of the touch inactive regions to be capable to communicate the wireless signals in accordance with one or more of: Near Field Communication (NFC) interface, Bluetooth interface, an RFID interface, a cellular interface, or an Institute of Electrical and Electronics Engineers (IEEE) 802.11 interface. Example 20 includes the computer-readable medium of example 18, further comprising one or more instructions that when executed on the at least one processor configure the at least one processor to perform one or more operations to cause the touch sensitive display device to communicate the wireless signals via a transparent antenna. Example 21 includes the computer-readable medium of example 18, further comprising one or more instructions that when executed on the at least one processor configure the at least one processor to perform one or more operations to cause the touch active regions to receive touch or stylus input. Example 22 includes the computer-readable medium of example 18, further comprising one or more instructions that when executed on the at least one processor configure the at least one processor to perform one or more operations to cause an integrated touch controller board to configure the touch sensitive display device into the one or more touch active regions and one or more touch inactive regions.

Example 23 includes a computing system comprising: a processor having one or more processor cores; a touch sensitive display device coupled to the processor; and logic to cause configuration of the touch sensitive display device into one or more touch active regions and one or more touch inactive regions, wherein the one or more of the touch inactive regions are capable to communicate wireless signals. Example 24 includes the system of example 23, wherein the one or more of the touch inactive regions are capable to communicate the wireless signals in accordance with one or more of: Near Field Communication (NFC) interface, Bluetooth interface, an RFID (Radio Frequency Identification) interface, a cellular interface, or an Institute of Electrical and Electronics Engineers (IEEE) 802.11 interface. Example 25 includes the system of example 23, wherein the touch sensitive display device is to comprise a transparent antenna to communicate the wireless signals. Example 26 includes the system of example 23, wherein data corresponding to one or more images to be displayed on the touch sensitive display device are to be received at a network interface from a host.

Example 27 includes an apparatus comprising means to perform a method as set forth in any preceding example. Example 28 comprises machine-readable storage including machine-readable instructions, when executed, to implement a method or realize an apparatus as set forth in any preceding example.

In various embodiments, the operations discussed herein, e.g., with reference to FIGS. 1-7, may be implemented as hardware (e.g., logic circuitry), software, firmware, or combinations thereof, which may be provided as a computer program product, e.g., including a tangible (e.g., non-transitory) machine-readable or computer-readable medium having stored thereon instructions (or software procedures) used to program a computer to perform a process discussed herein. The machine-readable medium may include a storage device such as those discussed with respect to FIGS. 1-7.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic, the logic at least partially comprising hardware logic, to cause configuration of a surface of a touch sensitive display device into one or more touch active regions and one or more touch inactive regions,
wherein the one or more of the touch inactive regions are capable to communicate wireless signals.

2. The apparatus of claim 1, wherein the one or more of the touch inactive regions are capable to communicate the wireless signals in accordance with one or more of: Near Field Communication (NFC) interface, Bluetooth interface, an RFID (Radio Frequency Identification) interface, a cellular interface, or an Institute of Electrical and Electronics Engineers (IEEE) 802.11 interface.

3. The apparatus of claim 1, wherein the touch sensitive display device is to comprise a transparent antenna to communicate the wireless signals.

4. The apparatus of claim 3, wherein the transparent antenna is to be provided by one or more technologies selected from a group comprising: metal mesh, FTO (Fluorine-Doped Tin Oxide), or inkjet printing.

5. The apparatus of claim 1, wherein the touch active regions are capable to receive touch or stylus input.

6. The apparatus of claim 1, wherein the display device is to comprise an integrated touch display device.

7. The apparatus of claim 6, wherein the integrated touch display device is one of an in-cell or an on-cell integrated touch display device.

8. The apparatus of claim 1, further comprising integrated touch controller board to configure the touch sensitive display device into the one or more touch active regions and one or more touch inactive regions in response to a request by the logic.

9. The apparatus of claim 1, wherein a portable computing device is to comprise the logic.

10. The apparatus of claim 9, wherein the portable computing device is to comprise one or more of: a System On Chip (SOC) device; a processor, having one or more processor cores; a flat panel display device, and memory.

11. The apparatus of claim 9, wherein the portable computing device is to comprise one of: a smartphone, a tablet, a phablet, a UMPC (Ultra-Mobile Personal Computer), a laptop computer, an Ultrabook™ computing device, and a wearable device.

12. The apparatus of claim 1, wherein one or more of the logic, a processor having one or more processor cores, one or more sensors, and memory are on a single integrated circuit die.

13. A method comprising:
configuring a surface of a touch sensitive display device into one or more touch active regions and one or more touch inactive regions,
wherein the one or more of the touch inactive regions are capable to communicate wireless signals.

14. The method of claim 13, further comprising the one or more of the touch inactive regions being capable to communicate the wireless signals in accordance with one or more of: Near Field Communication (NFC) interface, Bluetooth interface, an RFID interface, a cellular interface, or an Institute of Electrical and Electronics Engineers (IEEE) 802.11 interface.

15. The method of claim 13, further comprising the touch sensitive display device communicating the wireless signals via a transparent antenna.

16. The method of claim 13, further comprising the touch active regions receiving touch or stylus input.

17. The method of claim 13, further comprising an integrated touch controller board configuring the touch sensitive display device into the one or more touch active regions and one or more touch inactive regions.

18. A non-transitory computer-readable medium comprising one or more instructions that when executed on at least one processor configure the at least one processor to perform one or more operations to:
configure a surface of a touch sensitive display device into one or more touch active regions and one or more touch inactive regions,
wherein the one or more of the touch inactive regions are capable to communicate wireless signals.

19. The non-transitory computer-readable medium of claim 18, further comprising one or more instructions that when executed on the at least one processor configure the at least one processor to perform one or more operations to cause the one or more of the touch inactive regions to be capable to communicate the wireless signals in accordance with one or more of: Near Field Communication (NFC) interface, Bluetooth interface, an RFID interface, a cellular interface, or an Institute of Electrical and Electronics Engineers (IEEE) 802.11 interface.

20. The non-transitory computer-readable medium of claim 18, further comprising one or more instructions that when executed on the at least one processor configure the at least one processor to perform one or more operations to cause the touch sensitive display device to communicate the wireless signals via a transparent antenna.

21. The non-transitory computer-readable medium of claim 18, further comprising one or more instructions that when executed on the at least one processor configure the at least one processor to perform one or more operations to cause the touch active regions to receive touch or stylus input.

22. The non-transitory The computer-readable medium of claim 18, further comprising one or more instructions that when executed on the at least one processor configure the at least one processor to perform one or more operations to cause an integrated touch controller board to configure the touch sensitive display device into the one or more touch active regions and one or more touch inactive regions.

23. The apparatus of claim 3, wherein the transparent antenna is to be provided by ITO (Indium Tin Oxide).
